(19) United States
(12) Patent Application Publication
(10) Pub. No.: US 2016/0028334 A1
(43) Pub. Date: Jan. 28, 2016

(54) DRIVE CIRCUIT FOR A BRUSHLESS MOTOR (as amended)

(71) Applicant: DYSON TECHNOLOGY LIMITED, Wiltshire (GB)

(72) Inventors: Stephen GREETHAM, Gloucester (GB); Andrew Charlton CLOTHIER, Swindon (GB)

(73) Assignee: DYSON TECHNOLOGY LIMITED, Wiltshire (GB)

(21) Appl. No.: 14/773,251

(22) PCT Filed: Mar. 10, 2014
(86) PCT No.: PCT/GB2014/050712

§ 371 Date: Sep. 4, 2015

(30) Foreign Application Priority Data
Mar. 8, 2013 (GB) 1304269.2

(51) Int. Cl. H02P 6/00

(52) U.S. Cl. CPC H02P 6/002

(57) ABSTRACT

A drive circuit for a brushless motor comprising power lines for carrying an AC voltage, an inverter, and a controller. Each leg of the inverter is connected to a winding of the motor and comprises one or more bi-directional switches. The controller can output control signals that cause a pair of switches to conduct in one direction during the positive half-cycle of the AC voltage, and to conduct in the opposite direction during the negative half-cycle of the AC voltage. Alternatively, The controller can output control signals that cause a first pair of switches to conduct during the positive half-cycle of the AC voltage and a second pair of switches to conduct during the negative half-cycle of the AC voltage such that the winding is excited in the same direction irrespective of the polarity of the AC voltage.

### REFERENCES TO RELATED APPLICATIONS

This application is a national stage application under 35 USC 371 of International Application No. PCT/GB2014/050712, filed Mar. 10, 2014, which claims the priority of United Kingdom Application No. 1304269.2, filed Mar. 8, 2013, the entire contents of which are incorporated herein by reference.

### FIELD OF THE INVENTION

The present invention relates to a drive circuit for a brushless motor.

### BACKGROUND OF THE INVENTION

A brushless motor generally includes a drive circuit for controlling the excitation of phase windings of the motor. When powered by an AC voltage, the drive circuit often includes a rectifier, an active power factor correction (PFC) stage, and a bulk capacitor. Collectively, the rectifier, active PFC stage and bulk capacitor output a relatively stable DC voltage for use in exciting the phase windings. However, an active PFC stage is relatively costly. Additionally, the capacitance of the bulk capacitor is relatively high, and thus the capacitor is both large and costly.

WO2011/128659 describes a novel method of controlling the excitation of the phase windings. In particular, the phase windings are excited for a period of time that varies across each half-cycle of the AC voltage. As a result, the current drawn from the power supply approaches that of a sinusoid without the need for an active PFC stage or high-capacitance bulk capacitor.

### SUMMARY OF THE INVENTION

The present invention provides a drive circuit for a brushless motor, the drive circuit comprising power lines for carrying an AC voltage, an inverter comprising one or more legs connected in parallel across the power lines, each leg connected to a winding of the motor and comprising one or more bi-directional switches, and a controller for outputting one or more control signals for controlling the switches, wherein the controller outputs control signals to turn on and off each switch multiple times during each half-cycle of the AC voltage, and the controller outputs control signals to excite a winding of the motor, the control signals causing a pair of switches to conduct in a first direction during a positive half-cycle of the AC voltage and to conduct in a second opposite direction during a negative half-cycle of the AC voltage.

By employing bi-directional switches that can be controlled in both directions, and by generating controls signals that cause the switches to conduct in directions that depend on the polarity of the AC voltage carried on the power lines, the drive circuit is able to excite the phase winding using an AC voltage without the need for a rectifier or high-capacitance bulk capacitor. As a result, a more compact and potentially cheaper drive circuit may be realised.

The controller may turn on a first pair of switches so as to excite the winding during a positive half-cycle of the AC voltage to thereby drive current through the winding in a particular direction, and the controller may turn on a second different pair of switches so as to excite the winding during a negative half-cycle of the AC voltage to thereby drive current through the winding in the same particular direction. The drive circuit is therefore able to excite the winding in the same direction during both positive and negative half-cycles of the AC voltage.

The controller may output control signals to freewheel the winding. The control signals may then cause one of a pair of switches to conduct in a first direction and the other of the pair of switches to conduct in a second opposite direction during a positive half-cycle of the AC voltage to thereby freewheel current through the winding in a particular direction. Furthermore, the control signals may cause the one of the pair of switches to conduct in the second direction and the other of the pair of switches to conduct in the first direction during a negative half-cycle of the AC voltage to thereby freewheel current through the winding in the same particular direction. The drive circuit is therefore able to freewheel the winding in the same direction during both positive and negative half-cycles of the AC output voltage. If required, the drive circuit is additionally able to excite and freewheel the winding in both directions irrespective of the polarity of the AC voltage.

The present invention further provides a drive circuit for a brushless motor, the drive circuit comprising power lines for carrying an AC voltage, an inverter comprising one or more legs connected in parallel across the power lines, each leg connected to a winding of the motor and comprising one or more bi-directional switches, and a controller for outputting one or more control signals for controlling the switches, wherein the controller outputs control signals to turn on and off each switch multiple times during each half-cycle of the AC voltage, and the controller turns on a first pair of switches so as to excite the winding during a positive half-cycle of the AC voltage to thereby drive current through the winding in a particular direction, and the controller turns on a second different pair of switches so as to excite the winding during a negative half-cycle of the AC voltage to thereby drive current through the winding in the same particular direction.

By employing bi-directional switches that can be controlled in both directions, the drive circuit is able to drive the motor using an AC power supply without the need for a rectifier or high-capacitance bulk capacitor. Consequently, a potentially cheaper, smaller and/or more efficient drive circuit may be realised.

The drive circuit turns on a first pair of switches during a positive half-cycle of the AC voltage, and turns on a second pair of switches during a negative half-cycle of the AC voltage. As a result, the drive circuit is able to excite the winding in the same direction during both positive and negative half-cycles of the AC voltage. Consequently, the drive circuit may be used for unipolar excitation, e.g. if only the first pair of switches are turned on during the positive half-cycle of the AC voltage, and only the second pair of switches are turned on during the negative half-cycle of the AC voltage. Alternatively, the drive circuit may be used for bipolar excitation if both the first pair of switches and the second pair of switches are turned on sequentially during each half-cycle of the AC voltage.

The controller may output control signals to freewheel the winding. The control signals may then cause one of a pair of switches to conduct in a first direction and the other of the pair of switches to conduct in a second opposite direction during a positive half-cycle of the AC voltage to thereby freewheel current through the winding in a particular direction. Furthermore, the control signals may cause the one of the pair of switches to conduct in the second direction and the other of the pair of switches to conduct in the first direction during a negative half-cycle of the AC voltage to thereby freewheel current through the winding in the same particular direction. The drive circuit is therefore able to freewheel the winding in the same direction during both positive and negative half-cycles of the AC output voltage. If required, the drive circuit is additionally able to excite and freewheel the winding in both directions irrespective of the polarity of the AC voltage.

The controller may turn on and off at least one switch of the first pair of switches multiple times during the positive half-cycle of the AC voltage, and the controller may turn on and off at least one switch of the second pair of switches multiples times during the negative half-cycle of the AC voltage. This then enables the winding to be excited multiple times during each half-cycle of the AC voltage. Consequently, should current in the winding exceed a threshold, one of the switches from each pair may be turned off so as to suspend excitation. The other switch may then be kept on so as to allow current in the winding to freewheel through the switch. Additionally or alternatively, if the drive circuit is used for bipolar excitation then both switches of the first pair (or second pair) may be turned off and both switches of the second pair (or first pair) may be turned on in order to commutate the winding.

The present invention also provides a motor system comprising a brushless motor and a drive circuit as described in any one of the preceding paragraphs.

### BRIEF DESCRIPTION OF THE DRAWINGS

In order that the present invention may be more readily understood, embodiments of the invention will now be described, by way of example, with reference to the accompanying drawings, in which:

FIG. 1 is a block diagram of a motor system in accordance with the present invention;

FIG. 2 is a schematic diagram of the motor system;

FIG. 3 details the allowed states of the switches of the inverter in response to control signals issued by the controller of the motor system;

FIG. 4 illustrates the direction of current through the inverter and a phase winding of the motor in response to the control signals of the controller during excitation;

FIG. 5 illustrates the direction of current through the inverter and the phase winding in response to the control signals of the controller during freewheeling; and

FIG. 6 is a schematic diagram of an alternative motor system in accordance with the present invention.

### DETAILED DESCRIPTION OF THE INVENTION

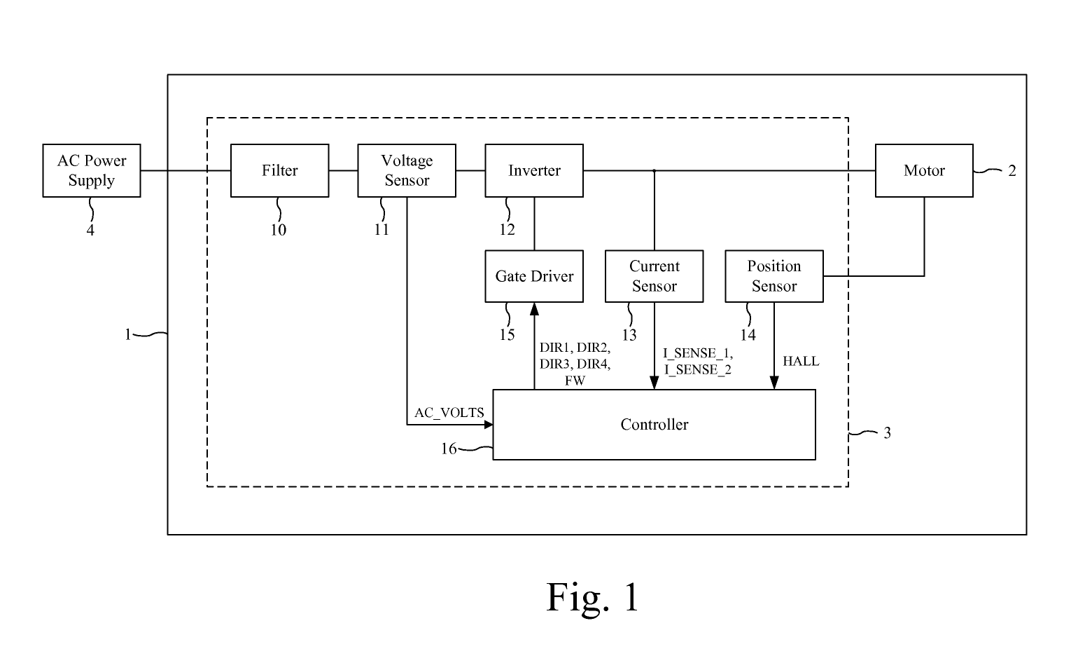

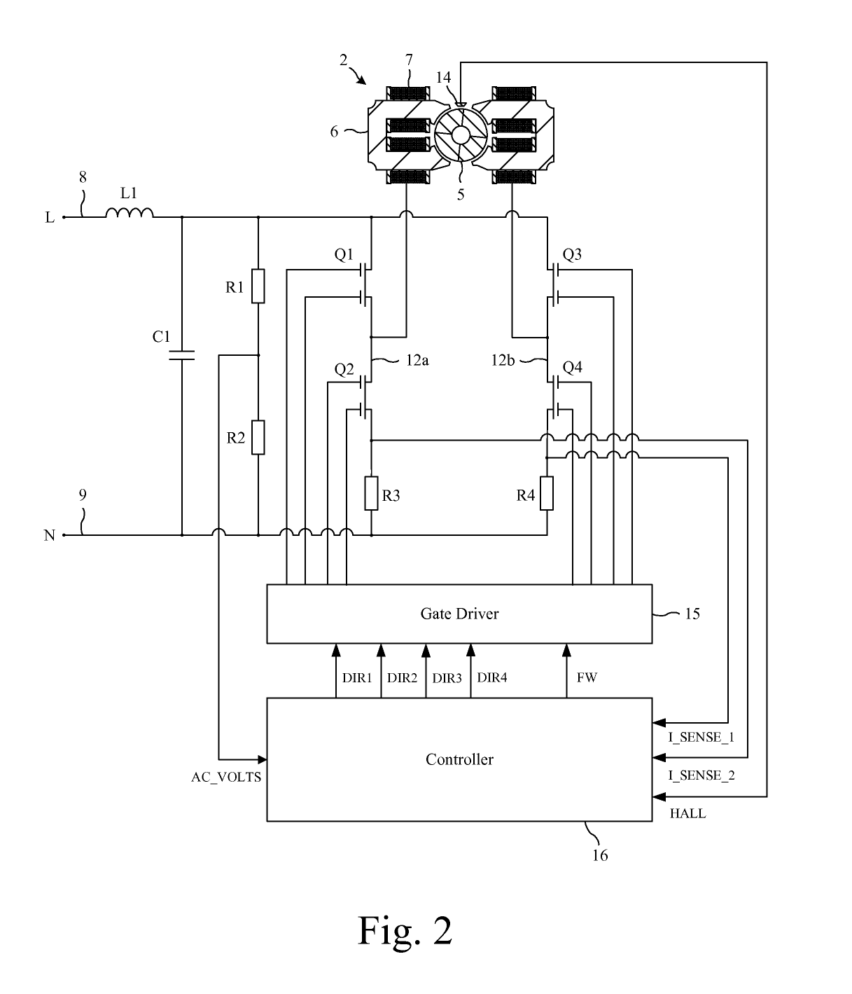

The motor system 1 of FIGS. 1 and 2 comprises a brushless motor 2 and a drive circuit 3. The motor system 1 is intended to be powered by an AC power supply 4, such as a domestic mains supply.

The motor 2 comprises a permanent-magnet rotor 5 and a stator 6 having a single phase winding 7.

The drive circuit 3 comprises a pair of power lines 8,9, a filter 10, a voltage sensor 11, an inverter 12, a current sensor 13, a position sensor 14, a gate driver 15 and a controller 16.

The power lines 8,9 are intended to be connected to the live and neutral terminals of the AC power supply 4. The power lines 8,9 thus carry an AC voltage.

The filter 10 comprises a capacitor C1 and an inductor L1. The capacitor C1 acts to smooth the relatively high dv/dt switching effects of the inverter 12. Additionally, the capacitor C1 acts to store the energy extracted from the motor 2 during commutation. Importantly, the capacitor C1 is not required to smooth the AC voltage at the fundamental frequency. Consequently, a capacitor of relatively low capacitance may be used. The inductor L1 acts to smooth any residual current ripple that arises primarily from motor commutation. Again, since the inductor L1 is intended to reduce ripple at the motor frequency, an inductor of relatively low inductance may be used, particularly when the motor 2 operates at relatively high speeds or has a relatively high number of poles.

The voltage sensor 11 comprises a pair of resistors R1,R2 arranged as a potential divider across the power lines 8,9. The voltage sensor 13 outputs to the controller 16 a signal, AC_VOLTS, which represents a scaled-down measure of the AC voltage across the power lines 8,9.

The inverter 12 comprises two legs 12a,12b connected in parallel across the power lines 8,9. The legs 12a,12b are connected to opposite terminals of the phase winding 7. Each leg 12a,12b comprises two switches Q1,Q2 and Q3,Q4 arranged in series. Each leg 12a,12b is then connected to the phase winding 7 at the junction point between the two switches.

The switches Q1-Q4 are bi-directional and can be controlled in both directions. That is to say that each switch Q1-Q4 is not only capable of conducting in both directions, but that the switch can be turned on and off in both directions. The switches Q1-Q4 thus differ from, say, a MOSFET having a body diode or a TRIAC. For example, whilst a MOSFET having a body diode is able to conduct in both directions, the switch can only be controlled in one direction. A TRIAC is capable of conducting in both directions and the point at which the switch is turned on (i.e. triggered) can be controlled in either direction. However, it is not possible to control the point at which the switch is turned off. In contrast, the switches Q1-Q4 of the present embodiment not only conduct in both directions but the points at which the switches Q1-Q4 are turned on and off can be controlled in both directions. As explained below, this is important since the switches Q1-Q4 are required to turn on and off multiple times during each half-cycle of the AC voltage.

The switches Q1-Q4 are gallium nitride switches having two gate electrodes. Each gate electrode is independently controllable such that the switch may be turned on and off in either direction. Gallium nitride switches have a relatively high breakdown voltage and are thus well-suited for operation at mains voltages. Nevertheless, other types of bi-directional switch that are capable of being controlled in both directions might alternatively be used.

The current sensor 13 comprises a pair of shunt resistors R3,R4, each resistor being located on a leg 12a,12b of the inverter 12. The voltages across the shunt resistors R3,R4 are output to the controller 16 as current sense signals, I_SENSE_1 and I_SENSE_2. The signals provide a measure of the current in the phase winding 7 during both excitation and freewheeling, as explained below in more detail.

The position sensor 14 is a Hall-effect sensor that outputs a digital signal, HALL, that is logically high or low depending on the direction of magnetic flux through the sensor 14. By locating the position sensor 14 adjacent the rotor 5, the HALL signal provides a measure of the angular position of the rotor 5.

The gate driver 15 is responsible for turning on and off the switches Q1-Q4 of the inverter 12. In response to control signals output by the controller 16, the gate driver 15 outputs signals for driving the gates of the switches Q1-Q4.

The controller 16 comprises a microcontroller having a processor, a memory device, and a plurality of peripherals (e.g. ADC, comparators, timers etc.). The memory device stores instructions for execution by the processor, as well as control parameters and lookup tables that are employed by the processor during operation. The controller 16 is responsible for controlling the operation of the motor system 1. In response to input signals received from the voltage sensor 11, the current sensor 13 and the position sensor 14, the controller 16 generates and outputs five control signals: DIR1, DIR2, DIR3, DIR4, and FW. The control signals are output to the gate driver 15, which in response turns on and off the switches Q1-Q4 of the inverter 12.

Each switch Q1-Q4 is bi-directional and can be turned on and off in both directions. Each switch therefore has three possible states: (1) ON and conducting in a first direction; (2) ON and conducting in a second direction; and (3) OFF and non-conducting. These three states will hereafter be referred to as UP, DOWN and OFF respectively. When a switch is turned UP, the switch conducts in direction from the neutral line to the live line. Conversely, when a switch is turned DOWN, the switch conducts in a direction from the live line to the neutral line. And when a switch is turned OFF, the switch fails to conduct in either direction.

DIR1, DIR2, DIR3 and DIR4 are drive signals that are used to control the direction of current through the inverter 12 and thus through the phase winding 7. When DIR1 is pulled logically high, the gate driver 15 turns DOWN switches Q1 and Q4. When DIR2 is pulled logically high, the gate driver 15 turns DOWN switches Q2 and Q3. When DIR3 is pulled logically high, the gate driver 15 turns UP switches Q2 and Q3. And when DIR4 is pulled logically high, the gate driver 15 turns UP switches Q1 and Q4. DIR1 and DIR2 are intended to be used when the AC voltage on the live line 8 is positive, and DIR3 and DIR4 are intended to be used when the AC voltage on the live line 8 is negative. When DIR1 is pulled high and the voltage on the live line 8 is positive or when DIR3 is pulled high and the voltage on the live line 8 is negative, current is driven through the phase winding 7 in a direction from left to right. Conversely, when DIR2 is pulled high and the voltage on the live line 8 is positive or when DIR4 is pulled high and the voltage on the live line is negative 9, current is driven through the phase winding 7 in a direction from right to left. In the event that all drive signals DIR1-DIR4 are pulled logically low, all switches Q1-Q4 of the inverter 12 are turned OFF.

FW is a freewheel signal that is used to disconnect the phase winding 7 from the AC voltage and allow current in the phase winding 7 to freewheel around the low-side loop of the inverter 12. Accordingly, when FW is pulled logically high, the gate driver 15 turns OFF both high-side switches Q1,Q3. The gate driver 15 then turns UP one of the low-side switches Q2,Q4 and turns DOWN the other of the low-side switches Q2,Q4. The low-side switches are turned UP or DOWN such that current continues to flow through the phase winding 7 in the same direction as that during excitation. Accordingly, when FW and either DIR1 or DIR3 are pulled logically high, the gate driver 15 turns UP switch Q2 and turns DOWN switch Q4 such that current continues to flow through the phase winding 7 in a direction from left to right. Conversely, when FW and either DIR2 or DIR4 are pulled logically high, the gate driver 15 turns DOWN switch Q2 and turns UP switch Q4 such that current continues to flow through the phase winding 7 in a direction from right to left.

Hereafter, the terms ‘set’ and ‘clear’ will be used to indicate that a signal has been pulled logically high and low respectively.

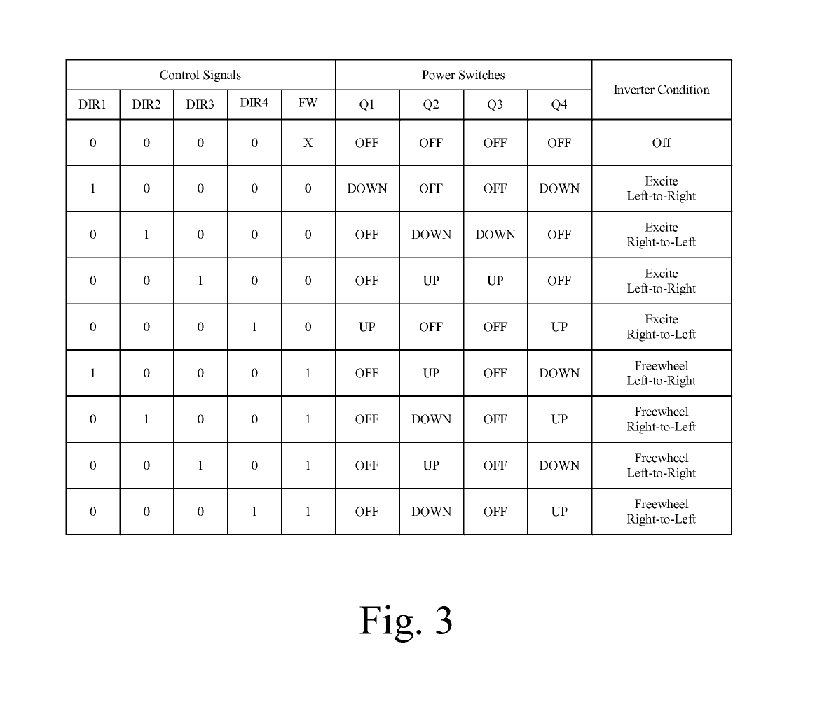

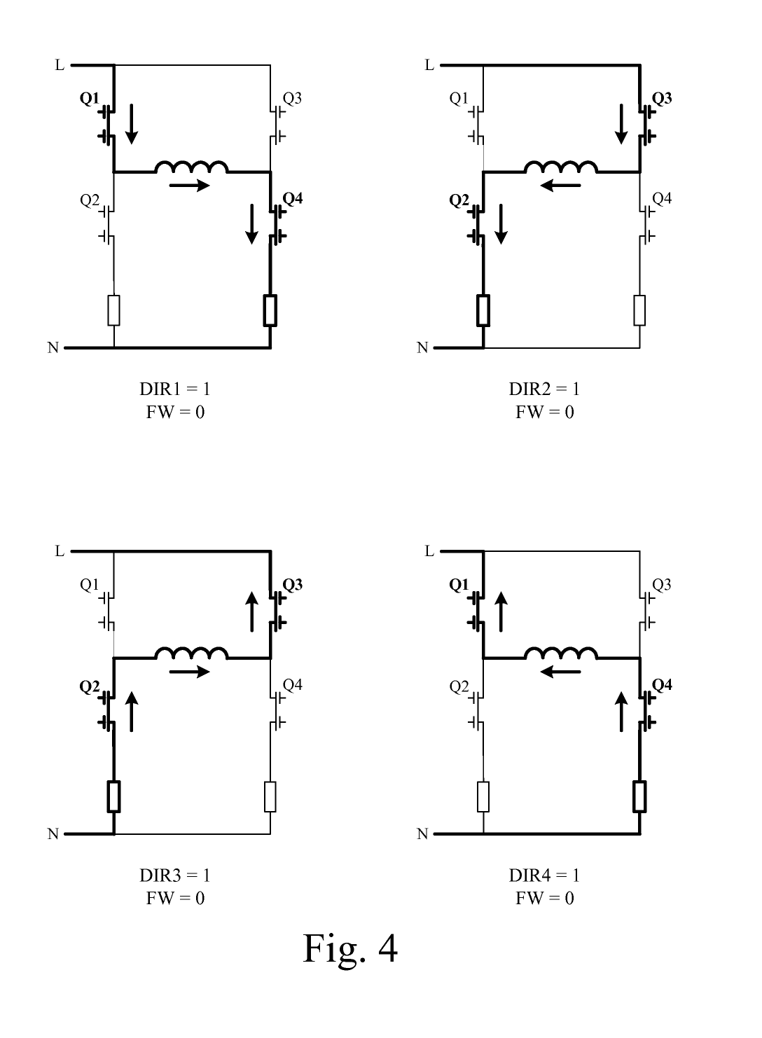

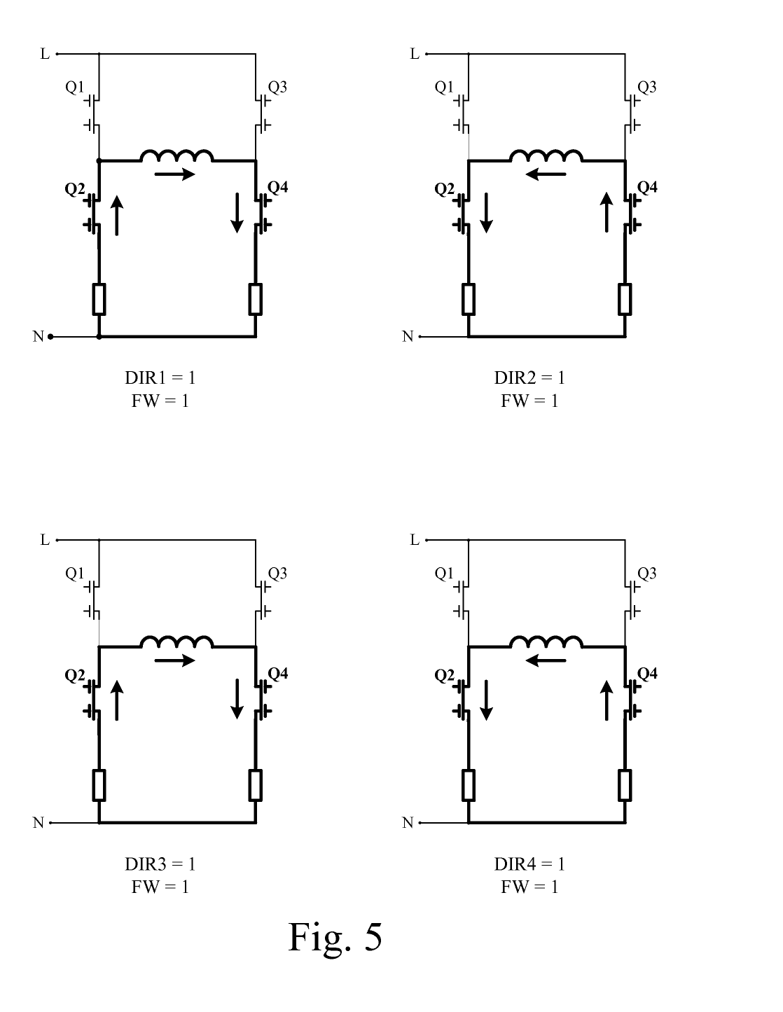

FIG. 3 summarises the allowed states of the switches Q1-Q4 in response to the control signals of the controller 16. FIGS. 4 and 5 illustrates the state of the inverter 12 and the direction of current through the phase winding 7 in response to the different control signals during excitation and freewheeling respectively.

In order to excite the phase winding 7 in a particular direction (e.g. left to right, or right to left), the controller 16 first senses the polarity of the AC_VOLTS signal output by the voltage sensor 13. In response to the sensed polarity, the controller 16 sets the drive signal, DIR1, DIR2, DIR3 or DIR4, necessary to excite the phase winding 7 in the required direction. So, for example, if the polarity of the AC_VOLTS signal is positive, the controller 16 sets DIR1 in order to excite the phase winding 7 from left to right, or DIR2 in order to excite the phase winding 7 from right to left. The phase winding 7 is commutated by reversing the direction of current through the phase winding 7. Accordingly, in order to the commutate the phase winding 7, the controller 16 senses the polarity of the AC_VOLTS signal and changes the drive signals so as to reverse the direction of excitation. So, for example, if DIR1 is currently set, and the polarity of the AC_VOLTS signal is positive then the controller 16 clears DIR1 and sets DIR2. Alternatively, if DIR1 is currently set and the polarity of the AC_VOLTS signal is negative then the controller 16 clears DIR1 and sets DIR4. Generally speaking, commutation involves switching between DIR1 and DIR2 when the voltage on the live line 8 is positive, and switching between DIR3 and DIR4 when the voltage on the live line 8 is negative. However, at zero-crossings in the AC voltage, commutation may involve switching between DIR1 and DIR4 or between DIR2 and DIR3. For reasons set out below, the phase winding 7 may be freewheeling immediately prior to commutation. Accordingly, in addition to changing the drive signals, the controller 16 also clears the freewheel signal, FW, in order to ensure that the phase winding 7 is excited on commutation.

Excessive currents may damage components of the drive circuit 3 (e.g. the switches Q1-Q4) and/or demagnetise the rotor 5. The controller 16 therefore monitors the current sense signals, I_SENSE_1 and I_SENSE_2, during excitation of the phase winding 7. In the event that current in the phase winding 7 exceeds a current limit, the controller 16 freewheels the phase winding by setting FW. Freewheeling continues for a freewheel period, during which time current in the phase winding 7 falls to a level below the current limit At the end of the freewheel period, the controller 16 again excites the phase winding 7 by clearing FW. As a result, current in the phase winding 7 is chopped at the current limit.

When the controller 16 makes a change to a particular control signal, there is generally a short delay between the changing of the control signal and the physical turning on or off of the relevant switches. As a result, it is possible for both switches (Q1,Q3 or Q2,Q4) on a particular leg 12a,12b of the inverter 12 to be turned on and conducting in the same direction at the same time. This short-circuit, or shoot-through as it is often termed, would then damage the switches on that particular leg of the inverter 12. Accordingly, in order to prevent shoot-through, the controller 16 employs a dead time between the changing of two control signals. So, for example, when switching between DIR1 and DIR2 in order to commutate the phase winding 7, the controller 16 first clears DIR1, waits for the dead time, and then sets DIR2. The dead time is ideally kept as short as possible so as to optimise performance whilst ensuring that the gate driver 15 and the switches Q1-Q4 have sufficient time to respond.

When a switch Q1-Q4 is turned off, the sudden change in current through the switch gives rise to a voltage transient that could exceed the rating of the switch. Accordingly, the inverter 12 may comprise means for protecting the switches Q1-Q4 against excessive transients. For example, the inverter 12 may comprise a snubber (not shown) connected in parallel with each of the switches Q1-Q4, or a single snubber (again, not shown) connected in parallel with the winding 7.

Operation of the motor system 1 will now be described.

The controller 16 operates in one of three modes depending on the speed of the rotor 5. At speeds below a first threshold, the controller 16 operates in Stationary Mode. At speeds above the first threshold but below a second threshold, the controller 16 operates in Acceleration Mode. At speeds above the second threshold, the controller 16 operates in Steady-State Mode. The speed of the rotor 5 is determined from the interval between successive edges of the HALL signal. This interval will hereafter be referred to as the HALL period.

Upon powering on the controller 16, the controller 16 senses the HALL signal. If the controller 16 fails to detect two edges in the HALL signal within a set period of time, the controller 16 determines that the speed of the rotor 5 is below the first threshold and the controller 16 enters Stationary Mode. Otherwise, the controller 16 waits until a further edge of the HALL signal is detected. The controller 16 then averages the time interval across the three edges to provide a more accurate measure of the rotor speed. If the speed of the rotor 5 is below the second threshold, the controller 16 enters Acceleration Mode. Otherwise, the controller 16 enters Steady-State Mode.

The controller 16 senses the HALL signal and the polarity of the AC_VOLTS signal, and excites the phase winding 7 in a direction that generates positive torque. For the purposes of the present discussion, positive torque will be said to be generated when the HALL signal is logically high and current is driven through the phase winding 7 from left to right, and when the HALL signal is logically low and current is driven through the phase winding 7 from right to left. The controller 16 then sets one of the drive signals DIR1-DIR4 so as to excite the phase winding 7 in a direction that generates positive torque and thus drives the rotor 5 forwards. So, for example, if the HALL signal is logically high and the polarity of the AC_VOLTS signal is positive, the controller 16 sets DIR1 so as to drive current through the phase winding 7 in a direction from left to right.

Exciting the phase winding 7 should cause the rotor 5 to rotate. The controller 16 monitors the HALL signal for the occurrence of an edge, which represents a transition in the polarity of the rotor 5. If no HALL edge is detected within a set period of time, the controller 16 determines that a fault has occurred and turns OFF all switches Q1-Q4 by clearing all control signals. Otherwise, the controller 16 commutates the phase winding 7 in response to the HALL edge. So, for example, if DIR1 is currently set and the polarity of the AC_VOLTS signal is positive, the controller clears DIR1, clears FW, and sets DIR2. After commutating the phase winding 7, the controller 16 enters Acceleration Mode.

When operating within acceleration mode, the controller 16 commutates the phase winding 7 in synchrony with the edges of the HALL signal. Each HALL edge corresponds to a change in the polarity of the rotor 5 and thus a change in the polarity of the back EMF induced in the phase winding 7 by the rotor 5. Consequently, when operating in Acceleration Mode, the controller 16 commutates the phase winding 7 in synchrony with zero-crossings in the back EMF.

The controller 16 monitors the current sense signals, I_SENSE_1 and I_SENSE_2, and freewheels the phase winding 7 whenever current in the phase winding 7 exceeds the current limit. The controller 16 therefore sequentially excites and freewheels the phase winding 7 over each electrical half-cycle of the motor 2.

The controller 16 continues to commutate the phase winding 7 in synchrony with each HALL edge until the speed of the rotor 5, as determined by the length of the HALL period, exceeds the second threshold. At this point, the controller 16 enters Steady-State Mode.

When operating in steady-state mode, the controller 16 may advance, synchronise or retard commutation relative to each HALL edge. In order to commutate the phase winding 7 relative to a particular HALL edge, the controller 16 acts in response to the preceding HALL edge. In response to the preceding HALL edge, the controller 16 subtracts a phase period, T_PHASE, from the HALL period, T_HALL, in order to obtain a commutation period, T_COM:

T_COM=T_HALL−T_PHASE

The controller 16 then commutates the phase winding 7 at a time, T_COM, after the preceding HALL edge. As a result, the controller 16 commutates the phase winding 7 relative to the subsequent HALL edge by the phase period, T_PHASE. If the phase period is positive, commutation occurs before the HALL edge (i.e. advanced commutation). If the phase period is zero, commutation occurs at the HALL edge (i.e. synchronous commutation). And if the phase period is negative, commutation occurs after the HALL edge (i.e. retarded commutation).

Advanced commutation may be employed in instances for which faster rotor speeds or higher shaft power are desired, whilst retarded commutation may be employed in instances for which lower rotor speeds or lower shaft power are desired. For example, as the speed of the rotor 5 increases, the HALL period decreases and thus the time constant (L/R) associated with the phase inductance becomes increasingly important. Additionally, the back EMF induced in the phase winding 7 increases, which in turn influences the rate at which phase current rises. It therefore becomes increasingly difficult to drive current and thus power into the phase winding 7. By commutating the phase winding 7 in advance of a HALL edge, and thus in advance of a zero-crossing in back EMF, the supply voltage is boosted by the back EMF. As a result, the direction of current through the phase winding 7 is more quickly reversed. Additionally, the phase current is caused to lead the back EMF, which helps to compensate for the slower rate of current rise. Although this then generates a short period of negative torque, this is normally more than compensated by the subsequent gain in positive torque. When operating at lower speeds, it may not be necessary to advance commutation in order to drive the required current into the phase winding 7. Moreover, improved efficiency may be achieved by synchronising or retarding commutation.

When operating in Stationary and Acceleration Modes, the controller 16 excites the phase winding 7 over the full length of each electrical half-cycle. In contrast, when operating in Steady-State Mode, the controller 16 excites the phase winding 7 over a conduction period, T_CD, that spans only part of each electrical half-cycle. At the end of the conduction period, the controller 16 freewheels the phase winding 7 by setting FW. Freewheeling then continues indefinitely until such time as the controller 16 commutates the phase winding 7. As in Stationary and Acceleration Modes, the controller 16 monitors the current sense signals, I_SENSE_1 and I_SENSE_2, and freewheels the phase winding 7 whenever current in the phase winding 7 exceeds the current limit Consequently, although the controller 16 may be said to excite the phase winding 7 over a conduction period, the controller 16 may chop the phase current one or more times within this conduction period.

The phase period, T_PHASE, defines the phase of excitation (i.e. the angle at which the phase winding 7 is excited relative to the angular position of the rotor 5) and the conduction period, T_CD, defines the length of excitation (i.e. the angle over which the phase winding 7 is excited). The controller 16 may adjust the phase period and/or the conduction period in response to changes in the AC voltage (be it the instantaneous value, the RMS value, or the peak-to-peak value) or speed of the rotor 5. For example, the controller 16 may adjust the phase period and/or the conduction period in response to changes in rotor speed so as to achieve constant power over a range of rotor speeds. Additionally, the controller 16 may adjust the phase period and/or the conduction period in response to changes in the instantaneous voltage of the AC voltage so as to achieve a good power factor. In particular, the controller 16 may adjust the phase period and/or the conduction period in the manner described in WO2011/128659.

The inverter 12 comprises switches Q1-Q4 that are bi-directional and can be controlled in both directions. The controller 16 then generates controls signals that control the states of the switches Q1-Q4 according to the polarity of the AC voltage carried on the power lines 8,9. In particular, during excitation of the phase winding 7, the controller 16 generates control signals that cause each switch Q1-Q4 to conduct in one direction during the positive half-cycle of the AC voltage, and to conduct in the opposite direction during the negative half-cycle. In the particular example described above, all switches Q1-Q4 are turned DOWN (i.e. conduct in a direction from the live line 8 to the neutral line 9) during the positive half-cycle of the AC voltage, and are turned UP (i.e. conduct in a direction from the neutral line 9 to the live line 8) during the negative half-cycle of the AC voltage. The drive circuit 3 is therefore able to excite the phase winding 7 over the full cycle of the AC voltage without the need for a rectifier or high-capacitance bulk capacitor. As a result, a more compact and potentially cheaper drive circuit 3 may be realised. Although the drive circuit 3 includes a capacitor C1, the capacitor C1 is used to smooth the relatively high-frequency ripple that arises from inverter switching. The capacitor C1 is not required to smooth the AC voltage at the fundamental frequency. Consequently, a capacitor of relatively low capacitance may be used.

The switches Q1-Q4 of the inverter 12, although bi-directional, are capable of conducting in one direction only at any one time. Accordingly, each switch Q1-Q4 has two gates and three possible states: (1) ON and conducting in a first direction; (2) ON and conducting in a second direction; and (3) OFF and non-conducting. However, bi-directional switches are available that can conduct in both directions at any one time. Such switches have only one gate and two states: (1) ON and conducting in both directions; and (2) OFF and non-conducting in both directions. Such switches may be employed in the inverter 12 of the drive circuit 3. Indeed, such switches have the advantage of simplify the number of control signals necessary to excite and freewheel the phase winding 7. For example, the controller 16 need only generate three control signals: DIR1′, DIR2′ and FW′. When DIR1′ is set, the gate driver 15 turns ON switches Q1 and Q4, and turns OFF switches Q2 and Q3. When DIR2′ is set, the gate driver 15 turns ON switches Q2 and Q3, and turns OFF switches Q1 and Q4. And when FW′ is set, the gate driver 15 turns OFF switches Q1 and Q3 and turns ON switches Q2 and Q4. In order to excite the phase winding 7 from left to right, the controller 16 senses the polarity of the AC_VOLTS signal and sets DIR1′ if the polarity is positive and sets DIR2′ if the polarity is negative. In order to excite the phase winding 7 from right to left, the controller 16 again senses the polarity of the AC_VOLTS signal and sets DIR2′ if the polarity is positive and sets DIR1′ if the polarity is negative. And in order to freewheel the phase winding 7, the controller 16 sets FW′ and the phase current circulates around the low-side loop of the inverter 12.

The controller 16 employs a particular scheme for controlling the magnitude of current in the phase winding 7. For example, the controller 16 freewheels the phase winding 7 for a set period of time whenever the magnitude of the phase current exceeds a current limit. Moreover, when operating in Steady-State Mode, the controller 16 employs a conduction period during which the phase winding 7 is excited, and the controller 16 adjusts the phase period and the conduction period in response to changes in the speed of the rotor 5 and/or the voltage on the power lines 8,9. Nevertheless, the present invention is predicated on the use of bi-directional switches that are controlled in such a way that, during excitation of the phase winding 7, each switch Q1-Q4 conducts in one direction during the positive half-cycle of the AC voltage, and each switch Q1-Q4 conducts in the opposite direction during the negative half-cycle. Within that restriction, the controller 16 may employ alternative schemes for controlling the magnitude of current in the phase winding 7. For example, rather than employing a current limit, the controller may instead use a PWM signal in order to control the magnitude of the phase current. This could be implemented, for example, by using a PWM module within the controller 16 to generate the PWM signal. The frequency and/or the duty cycle of the PWM signal may then be adjusted in response to changes in the speed of the rotor 5 such that each freewheel period does not become excessively long as the rotor accelerates.

In the embodiment described above, freewheeling involves turning OFF the high-side switches Q1,Q3 and allowing current in the phase winding 7 to re-circulate around the low-side loop of the inverter 12. Conceivably, freewheeling might instead involve turning OFF the low-side switches Q2,Q4 and allowing current to re-circulate around the high-side loop of the inverter 12. Accordingly, in a more general sense, freewheeling should be understood to mean that zero volts are applied to the phase winding 7. In the particular embodiment described above, freewheeling around the low-side loop of the inverter 12 has the advantage that the phase current may be sensed during both excitation and freewheeling. However, since freewheeling continues for a set period of time rather until the phase current drops below a lower current limit, it is not necessary to measure the phase current during freewheeling. To that end, although the current sensor 13 comprises two shunt resistors R3,R4, conceivably the current sensor 13 may comprise a single shunt resistor that is sensitive to the phase current during excitation only. As a further alternative, the current sensor 13 may comprise a current transformer or other transducer that is capable of sensing the phase current during both excitation and freewheeling.

The voltage sensor 11 described above provides the controller 16 with a measure of the polarity and the magnitude of the AC voltage. The polarity is used by the controller 16 to control the direction of current through the inverter 12 and thus through the phase winding 7. The magnitude of the voltage may be used by the controller 16 to adjust the phase period and/or the conduction period of excitation during Steady-State Mode. In the event that the magnitude of the AC voltage is not used by the controller 16, other means for measuring the polarity of the AC voltage may be employed. For example, the voltage sensor 11 may take the form of a zero-cross detector (e.g. pair of clamping diodes) that outputs a digital signal that is high when the AC voltage is positive and is low when the AC voltage is negative.

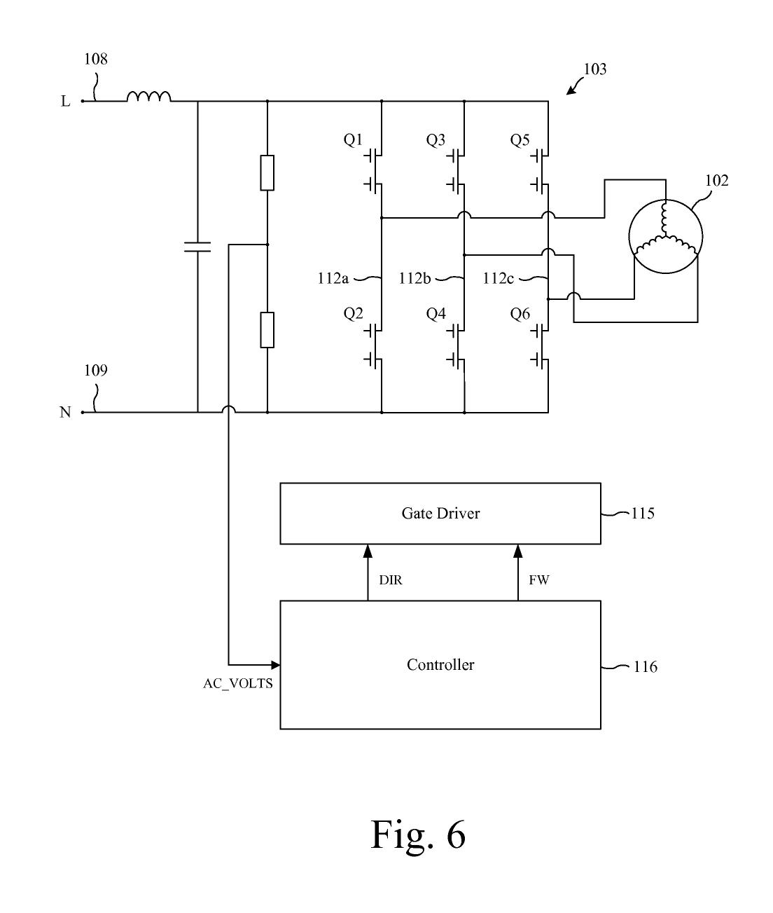

The drive circuit 3 described above is used to excite the phase winding 7 of a single-phase permanent-magnet motor 2. However, the drive circuit 3 may be used to excite the phase windings of other types of motor, including switched reluctance motors. By way of example only, FIG. 6 illustrates an alternative drive circuit 103 used to excite the phase windings of a three-phase motor 102. The motor 102 may be a permanent-magnet motor or a fully-pitched switched reluctance motor having bipolar excitation. The inverter 112 of the drive circuit 103 comprises three legs 112a,112b,112c, each leg being connected to a phase winding and comprising two bi-directional switches connected in series. For the purposes of clarity, the connections between the gate driver 115 and the switches Q1-Q6 have been omitted. Accordingly, in a more general sense, the drive circuit may be said to comprise an inverter having one or more legs connected in parallel across the power lines. Each leg is then connected to a phase winding of the motor and comprises one or more bi-directional switches. The controller then generates control signals for exciting a phase winding, and the control signals cause a pair of switches to conduct in a first direction during the positive half-cycle of the AC voltage and to conduct in a second opposite direction during the negative half-cycle of the AC voltage.

The drive circuit 3 described above provides bipolar excitation, i.e. the drive circuit 3 excites the phase winding 7 in both directions (left-to-right and right-to-left). However, the drive circuit 3 may equally be used to provide unipolar excitation. For example, the controller 16 may pull only DIR1 high during a positive half-cycle of the AC voltage, and pull only DIR3 high during a negative half-cycle of the AC voltage. As a result, current is driven through the phase winding 7 only in a direction from left to right. Irrespective of whether the drive circuit 3 is used to provide bipolar or unipolar excitation, the controller 16 closes a first pair of switches (e.g. Q1 and Q4) during a positive half-cycle of the AC voltage in order to drive current through the phase winding in a particular direction, and closes a second different pair of switches (e.g. Q2 and Q3) during a negative half-cycle of the AC voltage in order to drive current through the phase winding 7 in the same particular direction.

1. A drive circuit for a brushless motor, the drive circuit comprising power lines for carrying an AC voltage, an inverter comprising one or more legs connected in parallel across the power lines, each leg connected to a winding of the motor and comprising one or more bi-directional switches, and a controller for outputting one or more control signals for controlling the switches, wherein the controller outputs control signals to turn on and off each switch multiple times during each half-cycle of the AC voltage, and the controller outputs control signals to excite a winding of the motor, the control signals causing a pair of switches to conduct in a first direction during a positive half-cycle of the AC voltage and to conduct in a second opposite direction during a negative half-cycle of the AC voltage.

2. The drive circuit of claim 1, wherein the controller turns on a first pair of switches so as to excite the winding during a positive half-cycle of the AC voltage to thereby drive current through the winding in a particular direction, and the controller turns on a second different pair of switches so as to excite the winding during a negative half-cycle of the AC voltage to thereby drive current through the winding in the same particular direction.

3. The drive circuit of claim 1, wherein the controller outputs control signals to freewheel the winding, and the control signals cause one of a pair of switches to conduct in a first direction and the other of the pair of switches to conduct in a second opposite direction during a positive half-cycle of the AC voltage to thereby freewheel current through the winding in a particular direction, and the control signals cause the one of the pair of switches to conduct in the second direction and the other of the pair of switches to conduct in the first direction during a negative half-cycle of the AC voltage to thereby freewheel current through the winding in the same particular direction.

4. A drive circuit for a brushless motor, the drive circuit comprising power lines for carrying an AC voltage, an inverter comprising one or more legs connected in parallel across the power lines, each leg connected to a winding of the motor and comprising one or more bi-directional switches, and a controller for outputting one or more control signals for controlling the switches, wherein the controller turns on a first pair of switches so as to excite a winding of the motor during a positive half-cycle of the AC voltage to thereby drive current through the winding in a particular direction, and the controller turns on a second different pair of switches so as to excite the winding during a negative half-cycle of the AC voltage to thereby drive current through the winding in the same particular direction.

5. The drive circuit of claim 4, wherein the controller outputs control signals to freewheel the winding, and the control signals cause one of a pair of switches to conduct in a first direction and the other of the pair of switches to conduct in a second opposite direction during a positive half-cycle of the AC voltage to thereby freewheel current through the winding in a particular direction, and the control signals cause the one of the pair of switches to conduct in the second direction and the other of the pair of switches to conduct in the first direction during a negative half-cycle of the AC voltage to thereby freewheel current through the winding in the same particular direction.

6. The drive circuit of claim 4, wherein the controller turns on and off at least one switch of the first pair of switches multiple times during the positive half-cycle of the AC voltage, and the controller turns on and off at least one switch of the second pair of switches multiples times during the negative half-cycle of the AC voltage.

7. A motor system comprising a brushless motor and a drive circuit of claim 1.

8. A motor system comprising a brushless motor and the drive circuit of claim 4.
